(19) United States
(12) Patent Application Publication
(10) Pub. No.: US 2024/0428641 A1
(43) Pub. Date: Dec. 26, 2024

(54) ARTICLE SUPPLY APPARATUS

(71) Applicant: BANDAI CO., LTD., Tokyo (JP)

(72) Inventors: Hajime KONDO, Tokyo (JP); Tatsushi IKARASHI, Tokyo (JP); Nobuo KUROKAWA, Tokyo (JP)

(21) Appl. No.: 18/751,197

(22) Filed: Jun. 22, 2024

(30) Foreign Application Priority Data
Jun. 22, 2023 (JP) 2023-102655

(51) Int. Cl. G07F 11/00

(52) U.S. Cl. CPC G07F 11/007

(57) ABSTRACT

An article supply apparatus comprises a main body, an article accommodation unit provided in the main body, and an article supply unit provided in the article accommodation unit, an article supply path through which an article supplied from the article supply unit is supplied to a supply port, wherein the supply path includes a first supply path provided in a first direction, and a second path provided in a second direction which is different from the first direction.

### CROSS-REFERENCE TO RELATED APPLICATIONS

The disclosure of Japanese Patent Application No. 2023-102655 filed on Jun. 22, 2023 including specification, drawings and claims is incorporated herein by reference in its entirety.

### TECHNICAL FIELD

The present invention relates to an article supply apparatus.

### BACKGROUND

As disclosed in, for example, Japanese Patent Application Publication No. 2007-34603, conventionally, a box-shaped main body, which is provided in an article supply apparatus, such as an automatic vending machine, accommodates a large number of sealed capsule articles. In the box-shaped body, a drum-shaped article holding unit is provided. The article holding unit has a plurality of article holding holes, in each of which one capsule article may be held. When the article holding unit is rotated, one of the capsule articles accommodated in the box-shaped main body is discharged therefrom.

### PRIOR ART

### Patent Documents

[Patent Document 1] Japanese Patent Application Publication No. 2007-34603

### SUMMARY

### Technical Problem

In the article supply apparatus disclosed in Japanese Patent Application Publication No. 2007-34603, the capsule articles, which are held by the rotating article holding member and are discharged one by one, have the same outer diameter size. In other words, there is a limitation on the size of the capsule articles handled by the article supply apparatus (automatic vending machine), so that there is a problem that it lacks versatility as to article supply.

It is an object of the present invention to provide an article supply apparatus in which the flexibility is improved.

### Solution to Problem

One of the aspects of the present invention is an article supply apparatus comprising a main body, an article accommodation unit provided in the main body, an article supply unit provided in the article accommodation unit, an article supply path through which an article supplied from the article supply unit is supplied to a supply port, wherein the supply path includes a first supply path provided in a first direction, and a second path provided in a second direction which is different from the first direction.

### Advantageous Effect of Invention

According to the present invention, it is possible to provide an article supply apparatus in which the flexibility is improved.

### BRIEF DESCRIPTION OF DRAWINGS

FIG. 1 is a perspective view of an external appearance of an article supply apparatus according to an embodiment of the present invention;

FIG. 2 is a vertical cross-sectional view of an article supply apparatus shown in FIG. 1, taken along a front and rear direction;

FIG. 3 is a perspective view of the article supply apparatus shown in FIG. 1, wherein an article accommodation unit is removed;

FIG. 4 is a perspective view of an article accommodation unit showing an inside thereof;

FIG. 5 is a partial plan view of a supply path which is viewed from an upper side thereof;

FIG. 6 is a partial perspective view of the supply path which is viewed from a front upper side thereof;

FIG. 7 is a plan view of an article which passes through an article passage hole; and

FIG. 8 is a cross-sectional view thereof taken along a line 7-7 shown in FIG. 7.

### DETAILED DESCRIPTION

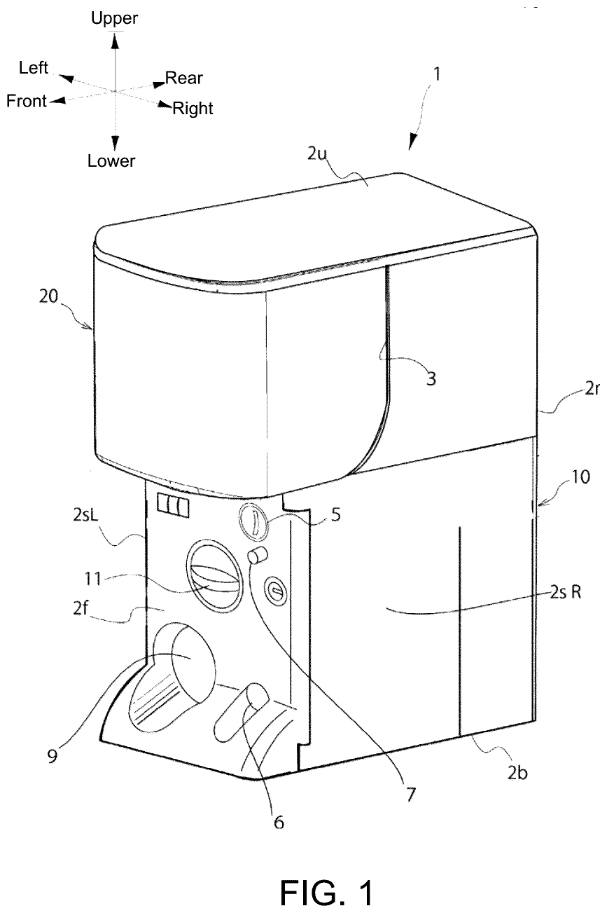

An article supply apparatus according to an embodiment of the present invention will be explained below, referring to drawings. FIG. 1 is a perspective view of an external appearance of an article supply apparatus according to this embodiment of the present invention.

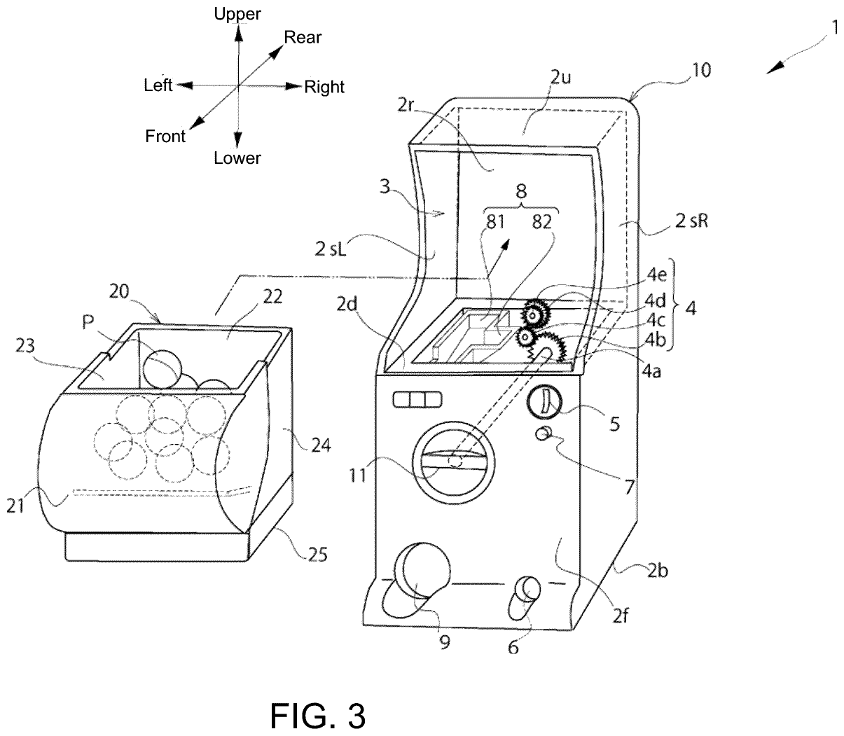

As shown in FIG. 1, the article supply apparatus 1 has a main body 10 in a box shape made up of a front wall 2f, a left side wall 2sL, a right side wall 2sR, a rear wall 2r, an upper wall 2u, and a bottom wall 2b, and various operation parts are provided on the front wall 2f thereof. On the front wall 2f, for example, a currency feeding port 5 capable of feeding consideration for an article P, a supply port 9 from which the article is discharged, an operation handle 11 for making it possible to supply the article P from the supply port 9 by performing a rotational operation thereof, a return port 6 for returning cash as needed, a currency return button 7 and so on. Additionally, an attachment section 3 (refer to FIG. 3) is formed on an upper side of the front wall 2f. The attachment section 3 has a large opening on a front face side thereof and a front face upper side thereof. The attachment section 3 is configured so that the accommodation unit 20, which accommodates the articles P, is detachable from the attachment section 3.

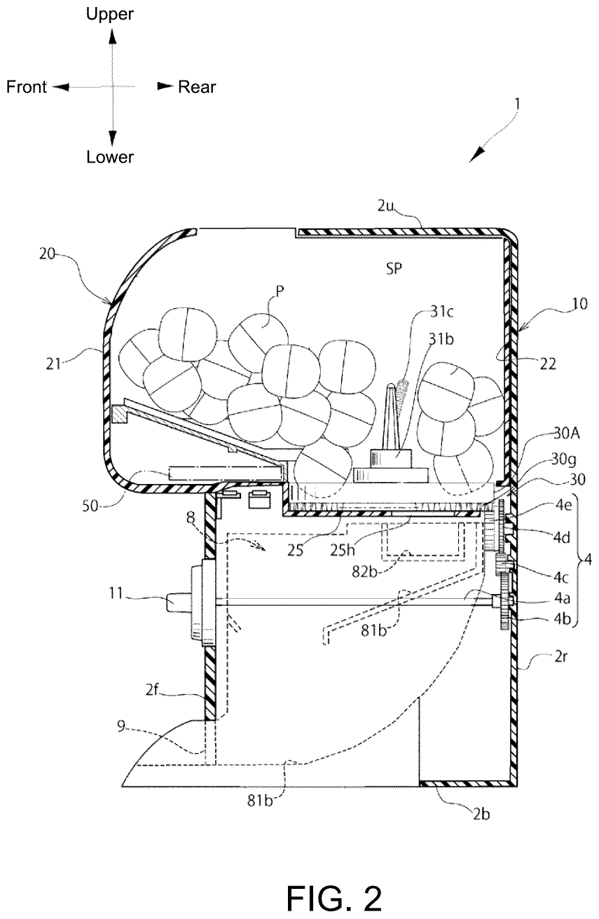

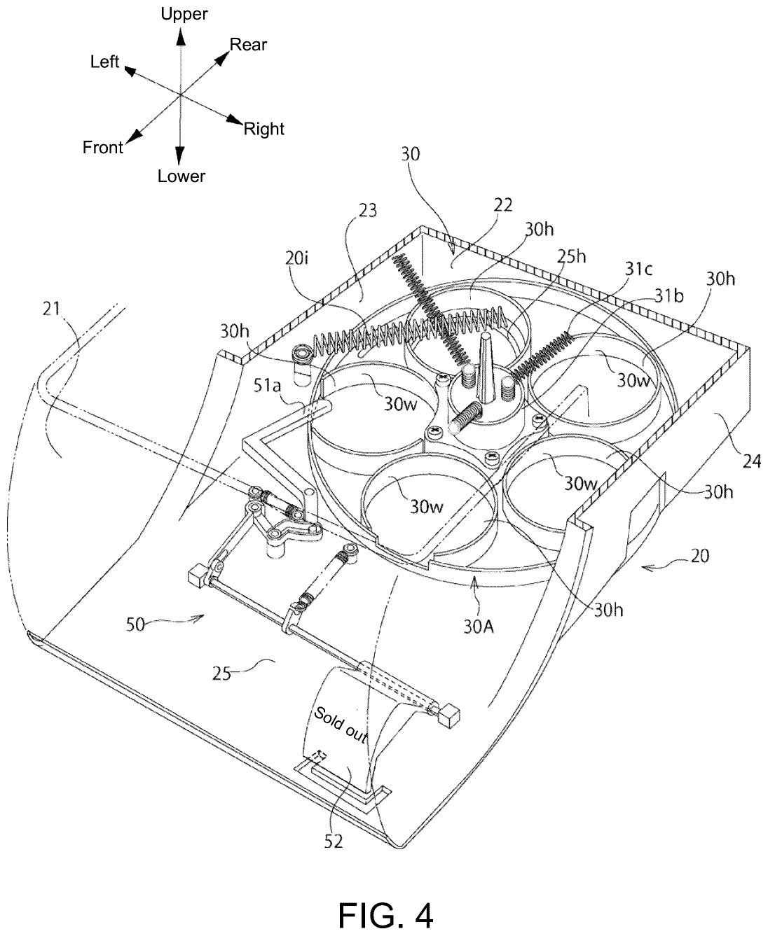

FIG. 2 is a vertical sectional view of the article supply apparatus 1, taken along a front-rear direction thereof. As shown in FIG. 2, the article accommodating unit 20, which has a storage space SP capable of accommodating a large number of articles P in a non-aligned state, is provided, in the main body 10 of the article supply apparatus 1. An article supply unit 30 (see FIG. 4) having a turntable 30A which is rotationally operated, is provided on a bottom wall portion 25 which is a bottom portion of the article accommodating unit 20. By this article supply unit 30, one article P is randomly selected from those in the article accommodating unit 20 and supplied. Here, the terms “article P” refer to a capsule-shaped container formed, for example, from synthetic resin material with appropriate rigidity. A toy or the like is enclosed in each of the articles P, which are configured to be easily rollable by themselves. Therefore, since the articles P are configured to have a readily rollable spherical shape, they can be supplied to the user's hand from the article supply apparatus 1 while avoiding separation or damage thereof during the supply.

Furthermore, the article supply apparatus 1 is equipped with a mechanism for restricting the operation of the article supply unit 30 (or locking the article supply unit 30), the operation handle 11 operable to release the lock conditionally upon payment of the price inserted from the currency feeding port 5 and to rotate the article supply unit 30, and a supply path 8, which allows the article P to pass through from the article supply unit 30 to the supply port 9 by rolling.

Moreover, on the rear wall 2r side, a gear mechanism 4 (gears 4b, 4c, 4d, 4e) capable of engaging with a rack gear 30g of the turntable 30A is provided. The operation handle 11 operable from the outside of the main body 10 is connected to a connecting shaft 4a, which is connected to this gear mechanism 4. Therefore, after payment of consideration, the turntable 30A of the article supply unit 30 is rotated by a rotational operation of the operation handle 11.

FIG. 3 is a perspective view of the article supply apparatus 1, wherein the article accommodating unit 20 is removed therefrom. As shown in FIG. 3, the article accommodating unit 20 is a box-shaped accommodation case with an open on a top side, comprising a front wall portion 21, a rear wall portion 22, a left side wall portion 23, a right side wall portion 24, and the bottom wall portion 25, which is a bottom of the article accommodating unit 20. And an article passage hole 25h capable of corresponding to each of article holding holes 30h of the turntable 30A therewith, is provided on a left rear side thereof (See FIGS. 2 and 4). Additionally, below an attachment base 2d of the attachment section 3, the supply path 8 for supplying the article P to the supply port 9 is provided on a left rear side thereof. This supply path 8 has an opening on an upper end side. As described below, this supply path 8 is configured to have a first supply path 81 and a second supply path 82. And, in a state where the article accommodating unit 20 is attached, the bottom wall portion 25 is configured to cover the upper side of the first supply path 81 and the second supply path 82. An article P, which drops from the third hole portion 25h is guided into the supply path 8 and discharged to the supply port 9.

FIG. 4 is a perspective view of the article accommodating unit 20 showing the inside thereof. As shown in FIG. 4, the bottom wall portion 25 of the article accommodating unit 20 is configured to have a lower face, forming a step on a rear side thereof (see FIG. 2), and the article supply unit 30 having the disc-shaped turntable 30A is arranged thereon so as to fit in this lower face. This turntable 30A includes, for example, a circular rack gear 30g (see FIG. 2) at a lower end of an outer peripheral edge thereof arranged on an upper side thereof. This turntable 30A has, for example, five article holding holes 30h arranged in the rotational direction. Additionally, on the bottom wall portion 25 of the article accommodating unit 20, as mentioned earlier, the article passage hole 25h is provided near the left side wall portion 23 and the rear wall portion 22. When an article P is supplied, the article P held by one of the article holding holes 30h passes through the third hole portion 25h and drops downward so that the article P is supplied to the supply port 9.

In addition, a central protrusion part 31b projecting upward is provided at the center of the turntable 30A, and an agitating member 31c, which is a spring member capable of agitating the randomly accommodated articles P is connected thereto. Further, above the article passage hole 25h, a spring member 20i is horizontally provided to prevent other articles P from interfering with the articles P held in the article holding holes 30h.

Here, in the article supply unit 30, a lock mechanism 50 for preventing rotation of the article supply unit 30 when the articles P run out, is provided as shown in FIG. 4, in addition to the lock mechanism which exerts by payment of consideration. For example, a tip portion of a locking arm 51a of the lock mechanism 50 arranged at a position on the front side of the bottom wall portion 25 of the article accommodating unit 20 advances into and catches one of the article holding holes 30h of the turntable 30A, thereby preventing the rotation of the article supply unit 30 when the articles P run out. At this time, a plate portion 52 indicating “Sold out” descends in front of the currency feeding port 5 to prevent coin insertion.

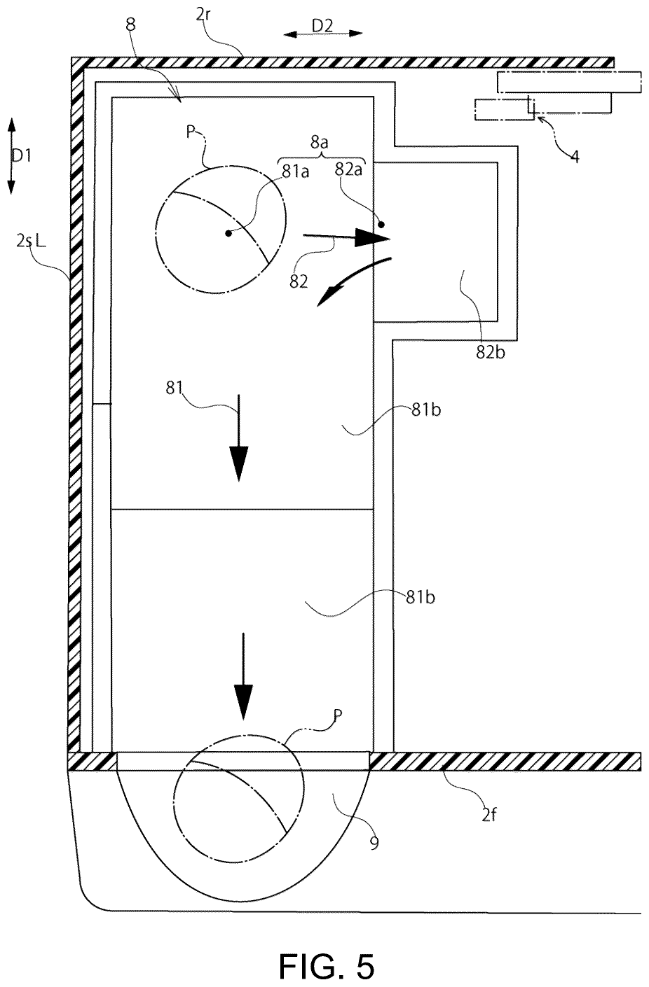

FIG. 5 is a schematic plan view of the supply path 8 viewed from above. As shown in FIG. 5, the supply path 8 is provided at a corner adjacent to the rear wall 2r and the left side wall 2sL of the main body 10. The supply path 8 has a first supply path 81 provided along a front and rear direction, which is a first direction D1, and the second supply path 82 provided along a second direction D2, which is a left and right direction, is different from the first direction D1 and intersects with the first direction D1 (for example at right angle). The second supply path 82 is provided on a right side of the first supply path 81 in FIG. 5, so as to be apart from both the right side wall 2sR and left side wall 2sL. The first supply path 81 is provided on a side of the left side wall 2sL (adjacent to the left side wall 2sL). Thus, the first supply path 81 is positioned so as to be sandwiched between the left side wall 2sL and the second supply path 82. In addition, contrary to the case shown in FIG. 5, when the first supply path 81 is provided on a side of the right side wall 2sR (adjacent to the right side wall 2sR), the second supply path 82 is arranged on the left side of the first supply path 81 (a position close to the center of the main body 10). In FIG. 5, this first supply path 81 is a path on which an article P rolls down toward the front side. The second supply path 82 is a path on which the article P falls down while moving in a right direction in the FIG. 5 and returns to and joins the first supply path 81 in the middle of the movement. As such, the second supply path 82 is configured to be connected to the first supply path 81, and the length of the second supply path 82 is shorter than that of the first supply path 81.

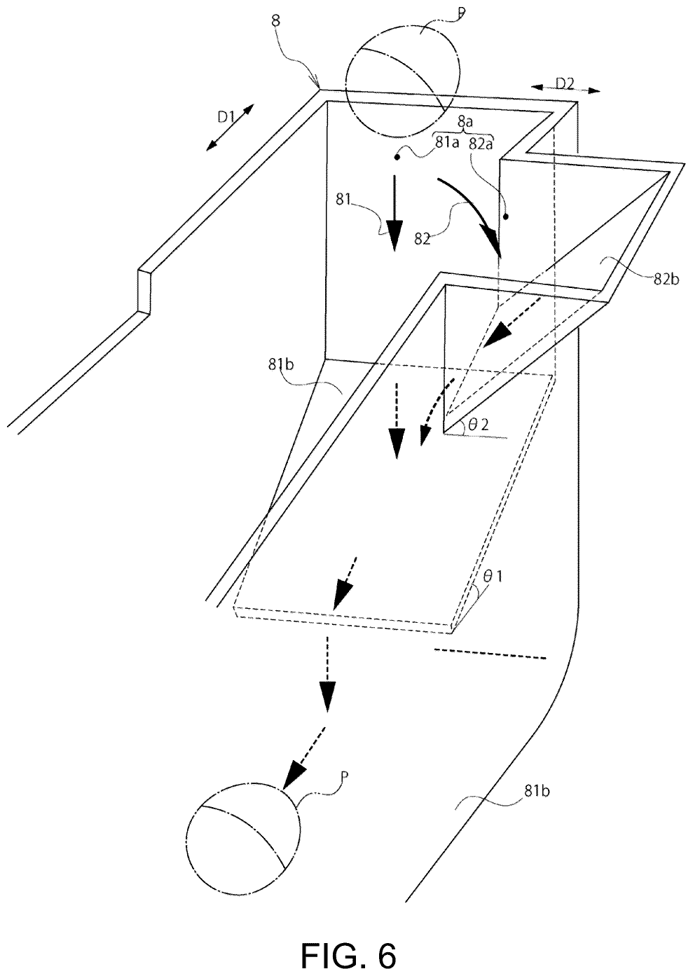

FIG. 6 is a partial perspective view of the supply path 8 viewed from the above. As shown in FIG. 6, in a state where the article accommodation unit 20 is removed (see FIG. 3), the first supply path and the second supply path of the supply path 8 are configured to be open on the respective upper sides. Therefore, an area on a rear side (in the figure) of the open portion of this upper part where an article P is charged, functions as a feeding port 8a. The feeding port 8a includes a first feeding port 81a for the article P passing through the first supply path 81 and a second feeding port 82a for the article P passing through the second supply path 82. Here, for convenience of explanation, the first supply path 81 on a side of the first supply path 81 and the second supply path 82 on a side of the second supply path 82 are distinguished from each other. However, in actuality, they are not divided areas but are connected to each other as a feeding port.

In addition, a bottom portion 82b of the second supply path 82 is located at a higher position than a bottom portion 81b of the first supply path 81. Further, the inclination θ1 of the bottom portion 81b of the first supply path 81 is easier than the inclination θ2 of the bottom portion 82b of the second supply path 82.

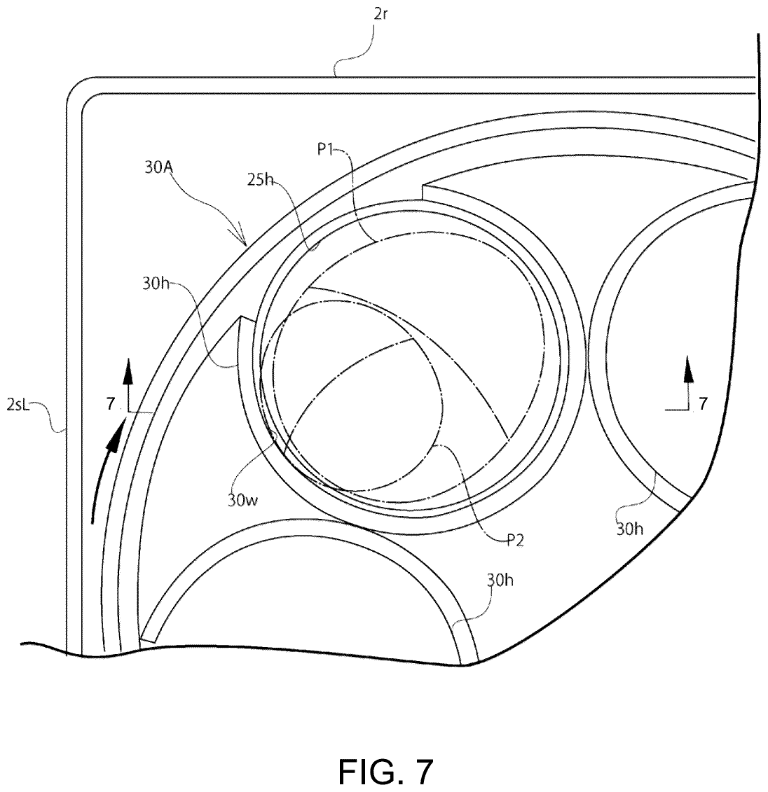

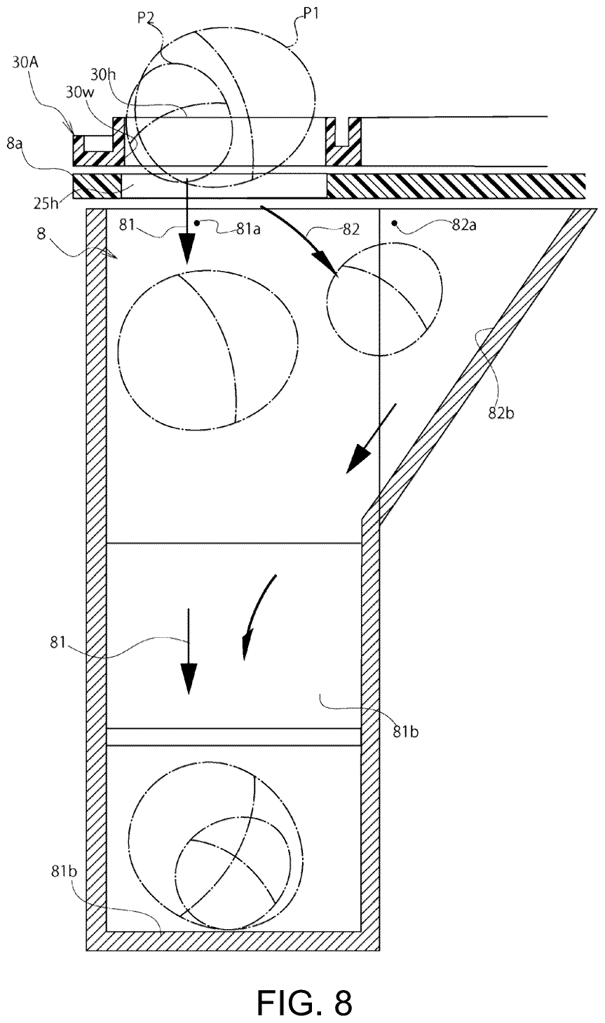

FIG. 7 is a plan view of article (P1, P2) which passes through the article passage hole 25h. FIG. 8 is a cross-sectional view thereof, taken along a line 7-7 shown in FIG. 7.

In case where an article P is charged in the supply path 8, the turntable 30A is rotated in a clockwise direction in the figure. By this movement, an article P held in one of the article holding holes 30h is moved to the article passage hole 25h and falls down therein. In this embodiment, the large article P1 is supplied to the supply path 8 in a different way from the case of the small article P2.

First, an explanation will be given below regarding the case where the large article P1 is supplied. In the case of the large article P1, as shown in FIG. 7, the article P1, which moves to the article passage hole 25h, starts to fall when the entire article P1 approximately reaches a point above the article holding hole 30h. This is because the large article P1 has a maximum diameter close to the size of the article passage hole 25h, and therefore, when the entire article P1 roughly faces the article passage hole 25h, the large article P1 is allowed to fall. That is, the article P1 starts to fall from a state where the article P1 is held (the position is regulated) by the article holding hole 30h. Additionally, when the article P1 falls through the article passage hole 25h, the article holding hole 30h and the article passage hole 25h almost overlap each other, and the turntable 30A is in a state where its rotational movement is stopped.

That is, the stopping of the turntable 30A and the start of the fall of the article P1 occur almost simultaneously. As a result, the rotational force of the turntable 30A does not significantly affect the article P1, and the article P1 begins to fall almost right below. Consequently, as shown in FIG. 8, the article P1 falls toward a side of a first feeding port 81a which is almost right below, and falls onto a bottom 81b of the first supply path 81, and the article P1 is supplied to the supply port 9 while rolling along the first supply path 81.

Next, an explanation will be given regarding when the small article P2 is supplied. In the case of the small article P2, when the small article P2 moves toward the article passage hole 25h, as shown in FIG. 7, since the rear side of the article P2 in the moving direction is pushed to the side wall 30w of the article holding hole 30h, a relatively large space between the article P2 and the front side of the side wall 30w is created. When the article P2 reaches the article passage hole 25h in this state, a rotational force of the turntable 30A is imparted to the article P2 by the rear side of the side wall 30w. In other words, the article P2 is thrown into the article passage hole 25h. As a result, both the gravity and a centrifugal force acts on the article P2, and as shown in FIG. 8, the article P2 follows its falling trajectory toward the bottom side 82b of the second supply path 82, and passes through the second supply path 82. The article P2, which falls in a side of the second supply path 82, falls on the bottom 82b of the second supply path 82 for the time being, and then moves into the first supply path 81 so as to be supplied to the supply port 9.

In this way, the second supply path 82 is configured to overlap with the falling trajectory of the article P2, which is imparted with centrifugal force, thereby ensuring that the article P2, which enters diagonally, can be reliably received.

In the above explanation, cases where the articles P, which differ in size from each other are described, but the falling trajectory of the articles P also vary when there is a difference in the weight thereof. For example, if the article P is heavy but even small in size, the centrifugal force resulting from the rotation of the turntable 30A has a lesser effect on the held article P. As a result, the probability that the article P passing and falling through the first supply path 81 side, increases. In other words, the falling trajectory of the article P does not necessarily pass through the second supply path 82 side, and their weight also influences the trajectory.

Here, the first feeding port 81a of the first feeding path 81 and the second feeding port 82a of the second supply path 82 form a connected opening without any division, thereby allowing variations in the falling trajectory due to changes in the size or weight of the article P.

As described above, in the article supply apparatus 1 of this embodiment, the supply path 8 for supplying the article P to the supply port 9 includes the first supply path 81, which is provided in the first direction D1, and the second supply path 82, which is provided in a second direction D2 different from the first direction D1. This configuration increases options for supplying the article P into the supply path 8.

In the article supply apparatus 1 according to the embodiment, when the detachable article accommodation unit 20 is attached to the main body 10, it can cover the upper parts (upper ends) of the first supply path 81 and the second supply path 82, and align the article passage hole 25h of the bottom wall 25 with the supply port. Additionally, since the second supply path 82 is connected to the first supply path 81, the different articles P can be supplied to a single supply port 9. Furthermore, the bottom 82b of the second supply path 82 is positioned higher than the bottom 81b of the first supply path 81, allowing the article P supplied to the second supply path 82 to fall into the first supply path 81.

Additionally, in the article supply apparatus 1 according to the embodiment, since the second supply path 82 is provided near the rear wall of the main body 10 and positioned away from the right and left side walls, the second supply path can be arranged to align with the first feeding port 81a of the first supply path 81.

Additionally, the first supply path 81 and the second supply path 82 are configured to allow the article P to roll, and the supply port for the article P connected to the supply path 8 is positioned on either a side of the right side wall or a side of the left side wall, and closer to the rear wall of the main body 10. By this configuration, it is possible to form a longer path on which the article P rolls and is supplied after falling, and to contribute to reduce the incline angle of the supply path 8 leading to the supply port 9 at the lower front end of the main body 10.

In the article supply apparatus 1 according to the embodiment, the turntable 30A is used as a means to supply the article P into the feeding port 8a. When the article P held by the turntable 30A is supplied into the supply path 8, the centrifugal force from the rotation of the turntable 30A is imparted to the article P. However, since the second supply path 82 is configured to overlap with the fall trajectory of the article P imparted with a centrifugal force, the article P can be reliably received by the second supply path 82 even if the falling trajectory changes due to the centrifugal force.

In the article supply apparatus 1 according to the embodiment, the supply path 8 is configured as a continuous feeding port 8a having an opening on the upper part. Therefore, even if the falling trajectory of the article P varies due to differences in size or weight, the article P can be reliably received and supplied to the supply port 9.

As described above, one embodiment of the present invention has been explained, but the present invention can be appropriately modified within the scope of its technical concept. For example, in the above embodiment, the five article holding holes 30h are provided, but the number of article holding holes is not limited thereto. For instance, the article holding holes 30 may be configured with four holes.

Additionally, in the above embodiment, the first supply path 81 is positioned closer to the left side wall 2sL of the main body 10, but this is not limited to this configuration. It can also be positioned closer to the right side wall 2sR.

As described above, matters as set forth below are disclosed in this specification.
(1) An article supply apparatus comprises a main body, an article accommodation unit provided in the main body, and an article supply unit provided in the article accommodation unit, an article supply path through which an article supplied from the article supply unit is supplied to a supply port, wherein the supply path includes a first supply path provided in a first direction, and a second path provided in a second direction which is different from the first direction.
(2) In the article supply apparatus according to (1), he second supply path is continuously connected to the first supply path.
(3) In the article supply apparatus according to (1) or (2), the second supply path is shorter than the first supply path.
(4) In the article supply apparatus according to any one of (1)-(3), a bottom portion of the second supply path is configured to be positioned higher than a bottom portion of the first supply path.
(5) In the article supply apparatus according to any one of (1)-(4), the second supply path is positioned beside a rear wall of the main body and apart from a right side wall and a left side wall.
(6) In the article supply apparatus according to (5), the first supply path is positioned on a side of either the right side wall or the left side wall of the main body.
(7) In the article supply apparatus according to (6), the first supply path is provided at a position where the first supply path is sandwiched between the second supply unit and either one of the right side wall and the left side wall.
(8) In the article supply apparatus according to any one of (1)-(7), the first supply path is configured so that an inclination of a bottom of the first supply path is easier than that of a bottom of the second supply path.
(9) In the article supply apparatus according to any one of (1)-(8), the first direction intersects with the second direction.
(10) In the article supply apparatus according to any one of (1)-(9), the article supply unit includes a turntable configured to hold the article, and the turntable is configured to impart a centrifugal force caused by a rotation of the turntable to the article.
(11) In the article supply apparatus according to (10), the second supply path is configured to overlap with a falling trajectory of the article to which the centrifugal force is imparted.
(12) In the article supply apparatus according to any one of (1)-(11), the first supply path and the second supply path are configured so that the article rolls.
(13) In the article supply apparatus according to any one of (1)-(12), an upper part of the first supply path and that of the second supply path are opened.
(14) In the article supply apparatus according to any one of (1)-(13), the article accommodation unit is configured to be detachable from the main body, and in a state where the article accommodation unit is attached to the main body, the article accommodation unit covers an upper part of the first supply path and that of the second supply path.
(15) In the article supply apparatus according to any one of (1)-(14), the article supply unit includes a turntable, which is configured to hold the article, and the turntable is configured to impart a centrifugal force caused by a rotation of the turntable, to the article, and wherein in case where two or more kinds of articles may be accommodated, the article which is susceptible to the centrifugal force, is supplied to the supply port through the second supply path.

1. An article supply apparatus comprising:
a main body;
an article accommodation unit provided in the main body;
an article supply unit provided in the article accommodation unit; and
an article supply path through which an article supplied from the article supply unit is supplied to a supply port,
wherein the supply path includes a first supply path provided in a first direction, and a second path provided in a second direction which is different from the first direction.

2. The article supply apparatus according to claim 1, wherein the second supply path is connected to the first supply path.

3. The article supply apparatus according to claim 2, wherein the second supply path is shorter than the first supply path.

4. The article supply apparatus according to claim 3, wherein a bottom portion of the second supply path is configured to be positioned higher than a bottom portion of the first supply path.

5. The article supply apparatus according to claim 1, wherein the second supply path is positioned beside a rear wall of the main body and apart from a right side wall and a left side wall.

6. The article supply apparatus according to claim 5, wherein the first supply path is positioned adjacent to either one of the right side wall and the left side wall of the main body.

7. The article supply apparatus according to claim 6, wherein the first supply path is provided at a position where the first supply path is sandwiched between the second supply unit and either one of the right side wall and the left side wall.

8. The article supply apparatus according to claim 1, wherein the first supply path and the second supply path are configured so that an inclination of a bottom of the first supply path is easier than that of a bottom of the second supply path.

9. The article supply apparatus according to claim 8, wherein the first direction intersects with the second direction.

10. The article supply apparatus according to claim 1, wherein the article supply unit includes a turntable configured to hold the article, and the turntable is configured to impart a centrifugal force caused by a rotation of the turntable, to the article.

11. The article supply apparatus according to claim 10, wherein the second supply path is configured to overlap with a falling trajectory of the article to which the centrifugal force is imparted.

12. The article supply apparatus according to claim 1, wherein the first supply path and the second supply path are configured so that the article rolls.

13. The article supply apparatus according to claim 1, wherein an upper part of the first supply path and that of the second supply path are opened.

14. The article supply apparatus according to claim 1, wherein the article accommodation unit is configured to be detachable from the main body, and in a state where the article accommodation unit is attached to the main body, the article accommodation unit covers an upper part of the first supply path and that of the second supply path.

15. The article supply apparatus according to claim 1, wherein the article supply unit includes a turntable, which is configured to hold the article, and the turntable is configured to impart a centrifugal force caused by a rotation of the turntable, to the article, and wherein in case where two or more kinds of articles having different weights may be accommodated, the article which is more susceptible to the centrifugal force, is supplied to the supply port through the second supply path.
